(19) United States
(12) Patent Application Publication
(10) Pub. No.: US 2024/0228802 A9
(43) Pub. Date: Jul. 11, 2024

(54) METHOD FOR PREPARING METAL INK AND ADDITIVE MANUFACTURING BASED ON PHOTO-THERMAL SYNERGISTIC CURING

(71) Applicant: JIANGNAN UNIVERSITY, Wuxi City (CN)

(72) Inventors: Ren LIU, Wuxi City (CN); Guo Wei, Wuxi City (CN); Junzhao Yuan, Wuxi City (CN); Xinxin Sang, Wuxi City (CN)

(21) Appl. No.: 18/457,642

(22) Filed: Aug. 29, 2023

(30) Foreign Application Priority Data
Oct. 21, 2022 (CN) 202211296264.7

(51) Int. Cl. C09D 11/037; B22F 10/10; B22F 10/64; B33Y 10/00; B33Y 40/20; B33Y 70/10; C09D 11/101; C09D 11/102; C09D 11/107

(52) U.S. Cl. CPC C09D 11/037; B22F 10/10; B22F 10/64; B33Y 10/00; B33Y 40/20; B33Y 70/10; C09D 11/101; C09D 11/102; C09D 11/107; B22F 2201/11; B22F 2201/12; B22F 2301/10

(57) ABSTRACT

A method is described for preparing metal ink for additive manufacturing based on photo-thermal synergistic curing, relating to functional ink technology. The ink includes 50%-95% metal powder, 1%-35% photosensitive resin, 1%-35% photosensitive monomer, 0.1%-7% photoinitiator, 0.1%-5% thermal initiator, 0.1%-5% up-conversion material, and 0%-2% auxiliary agent. The method includes adding metal ink to the ink tank of a direct ink writing 3D printer, extruding the metal ink from the nozzle under computer control to the printing specific shapes on the platform, and curing under real-time illumination of a specific light source to obtain the green body. The method includes performing high-temperature debinding treatment on the obtained green body in a specific atmosphere. The treated green body is subjected to a high-temperature and high-pressure sintering treatment in a specific atmosphere and then cooled to room temperature.

### BACKGROUND OF THE INVENTION

### 1. Technical Field

The present invention relates to the field of functional ink technology, in particular to a method for preparing metal ink and its additive manufacturing based on photo-thermal synergistic curing.

### 2. Description of Related Art

Metal additive manufacturing technology is widely used in medical, automotive, aerospace and other fields. At present, the main methods of metal additive manufacturing include selective laser (electron beam) metal powder melting, laser (electron beam) metal direct deposition, binder jetting, fused deposition modeling, metal stereolithography, etc. These metal additive manufacturing technologies have been industrialized to varying degrees. However, the existing metal additive manufacturing technologies mentioned above still have varying degrees of limitations.

The technology of photopolymerization assisted metal direct ink writing additive manufacturing has been reported, which can achieve additive manufacturing of multi metal materials and heterogeneous metal materials. However, due to the poor penetration of light in metal ink and insufficient curing depth, it is difficult to realize unsupported printing, which greatly limits the application of this method. In order to improve the UV curing depth of ink, in existing patent reports, near-infrared is used as the curing light source. However, due to the high light shielding characteristics of metal ink, its curing depth is still limited, making it impossible to achieve real-time curing of metal ink. The additive manufacturing of metallic unsupported structure is still a challenge that the industry has not overcome.

### SUMMARY OF THE INVENTION

The present invention provides a method for preparing metal ink and additive manufacturing based on photo-thermal co curing, in response to the aforementioned problems in the existing technology. The present invention is based on the synergistic effect of light and heat, effectively improving the curing depth and curing speed of ink, and achieving the additive manufacturing of the unsupported structure. The additive manufacturing of multi-metal materials can be achieved through the joint action of multiple nozzles or coaxial nozzles.

The technical solution of the present invention is as follows:

A metal ink based on photo-thermal co curing, wherein the raw materials contained in the metal ink and the mass percentage of each raw material are:
Metal powder 50%-95%
Photosensitive resin 1%-35%
Photosensitive monomer 1%-35%
Photoinitiator 0.1% to 7%
Thermal initiator 0.1%-5%
Up-conversion material 0.1%-5%
Auxiliary agent 0%-2%;

The metal powder is one or more of iron, copper, aluminum, silver, tin, magnesium, nickel, titanium, vanadium, chromium, manganese, cobalt, nickel, zinc, gallium, germanium, aluminum alloy, copper alloy, stainless steel alloy, and nickel alloy.

Preferably, the morphology specifications of the metal powder are one or more of spherical, needle like, rod like, or sheet like; The particle size of the metal powder ranges from 50 nm to 500 μm.

Further optimization, The metal powder is spherical with a particle size of 5-100 μm.

The photosensitive resin is one or more of epoxy acrylate, polyurethane acrylate, polyester acrylate, and polyether acrylate.

Preferably, an aliphatic photosensitive resin containing a long chain alkyl group or a hydroxyl (carboxyl) group structure. The number of carbon atoms in long straight or branched alkyl chains is 5-18; The equivalent of hydroxyl (carboxyl) groups is 50-2000 mol/g.

Further optimized, the photosensitive resin is one or more of Changxing 6261, 622-100, 622A-80, Ruiyang RY1202, RY1201, LOHO EPD-171, EPD-172.

The photosensitive monomer is one or more of acrylate monomers, epoxy monomers, or vinyl ether monomers.

It is further preferred that the photosensitive monomer is one or more of di-pentaerythritol pentaacrylate, pentaerythritol triacrylate, trimethylolpropane triacrylate, 3,4-epoxycyclohexylmethyl 3,4-epoxycyclohexanecarboxylate, and triethylene glycol divinyl ether.

The photoinitiator is a photolysis type free radical photoinitiator, a hydrogen capture type free radical photoinitiator, or a cationic photoinitiator;

Preferably, the pyrolytic free radical photoinitiator is benzoin and its derivatives, benzoyl and its derivatives, acetophenone derivatives α-Hydroxyl ketone derivatives α-one or more of amine ketone derivatives, acyl phosphine oxides, and sulfur-containing photoinitiators;

The hydrogen capture free radical photoinitiator is one or more of benzophenone and its derivatives, thioanthracene ketone and its derivatives, anthraquinone and its derivatives.

Further preferred photoinitiator with high activity and long wavelength absorption.

Further preferably, the photoinitiator is one or more of 2, 4, 6-trimethyl Benzoyl group-Diphenylphosphine oxide (I-TPO), bis (2, 4, 6-trimethyl Benzoyl group) phenyl Phosphine oxide(I-819),bis (2,6-difluoro-3-(1H pyrrolyl-1) phenyl) titanocene (I-784).

The thermal initiator is one or more of organic peroxides initiator, inorganic peroxide initiator, azo initiator and redox initiator.

Preferably, a thermal initiator with an initiation temperature ranging from 60° C. to 100° C.

Further preferably, the thermal initiator is one or more of 2,2′-Azobis(2-methylpropionitrile) (AIBN) and benzoyl peroxide (BPO).

The up-conversion material is one or more of NaYF4, BaYF5, NaGdF4, LiYF4, NaYbF4, Na3ScF6, YF3, GdOF; The auxiliary agent is one or more of defoamers, anti-settling agents, and rheological agents.

A preparation method for metal ink based on photo-thermal synergistic curing, comprising the following steps (each raw material is measured by mass percentage):
(1) Add 50%-95% metal powder, 1%-35% photosensitive resin, 1%-35% photosensitive monomer, 0%-2% auxiliary agent, and 0.1%-5% up-conversion material to the ball milling tank, add ceramic balls to the ball milling tank, seal the ball milling tank, and mix evently on the ball milling machine at a speed of 2000-5000 r/min;
(2) Then add 0.1%-7% photoinitiator and 0.1%-5% thermal initiator to the ball milling tank, seal the ball milling tank, and mix evenly on the ball mill at a speed of 1000-2000 r/min;
(3) Finally, the ink is filtered through a filter to remove mechanical impurities, and then packaged in a sealed container for storage in a dark place. A method for manufacturing using the metal ink additive, comprising the following steps:
(1) Add the metal ink to the ink tank of the direct ink writing 3D printer, extrude the metal ink from the nozzle under computer control to the printing platform, and solidify under real-time illumination of a specific light source to obtain the green body;
(2) Perform high-temperature debinding treatment on the green body obtained in step (1) in a specific atmosphere;
(3) The green body treated in step (2) is subjected to high-temperature and high-pressure sintering treatment in a specific atmosphere, and then cooled to room temperature.

In step (1), the specific light source is a laser light source with a wavelength of 10 nm to 2000 nm;

Preferably, the specific light source is a laser light source with a wavelength of 800-1000 nm;

In step (2), the specific atmosphere is one or more mixed gas atmospheres of oxygen, nitrogen, argon, helium, neon, krypton, xenon, and radon;

Preferably, the specific atmosphere is one or more of oxygen, nitrogen, or argon.

Further optimization, negative pressure atmosphere.

In step (2), the high-temperature debinding treatment temperature is between 250° C. and 600° C.

In step (3), the specific atmosphere is one or more mixtures of hydrogen, nitrogen, argon, helium, neon, krypton, xenon, and radon.

Preferably, the specific atmosphere is one or more of hydrogen, nitrogen, or argon.

In step (3), the temperature for high-temperature and high-pressure sintering treatment is 550° C.˜1500° C., and the pressure is 0.5 MPa˜980 MPa;

In steps (2) and (3), the heating and cooling rates are 0.1° C. to 50° C./min.

Further optimization, the heating and cooling rates are 0.1° C. to 5° C./min.

The beneficial technical effects of the present invention lie in:
The metal ink of the present invention is simultaneously added with photoinitiators and thermal initiators. Under the irradiation of a specific light source, the up-conversion material emits ultraviolet light, causing the photoinitiator to decompose and produce free radical reactive species, which completes curing in the shallow layer of the ink; at the same time, the thermal effect of laser combined with the high thermal conductivity of metal powder enables the rapid decomposition of the thermal initiator in the system to produce free radical reactive species, completing the overall curing of the ink.

The present invention utilizes this photo-thermal synergistic effect to improve the curing speed and depth of ink, and real-time curing during the printing process can achieve additive manufacturing of unsupported structure. Overcoming the industry challenge of unsupported structure printing in metal additive manufacturing, which is difficult to be completed with existing technology.

The printing green body in the present invention can obtain a dense structure after high-temperature and high-pressure sintering treatment under a specific atmosphere

### BRIEF DESCRIPTION OF THE DRAWINGS

FIG. 1 shows the viscosity of the metal ink from embodiments 1-2 and comparative example 1 of the present invention;

FIG. 2 shows the real-time infrared curves of the metal ink embodiment 3 and comparative examples 2-3 of the present invention;

FIG. 3 shows the curing depth of metal ink embodiment 3 and comparative examples 2-3 of the present invention;

FIG. 4 shows the unsupported printing spiral structure of embodiment 3 (a) and comparative example 3 (b) of the present invention.

### DETAILED DESCRIPTION OF THE INVENTION

The present invention will be described in detail below in conjunction with the accompanying drawings and embodiments.

### Embodiment 1

A metal ink based on photo-thermal synergistic curing, prepared as follows: (Each raw material is measured by mass percentage)

Add 89.4% copper powder (spherical, particle size 45 μm), 4.5% RY1202, 4% di pentaerythritol pentaacrylate, 1% NaYF4 and 0.1% BYK-028 are added to the ball mill, ceramic balls are added to the ball mill, the ball mill is closed, and placed on the ball mill at a speed of 3500 r/min to mix evenly; Then add 0.5% I-819 and 0.5% AIBN to the ball milling tank, close the ball milling tank, and mix evenly at a speed of 1500 r/min on the ball mill; Finally, the ink is filtered through a filter to remove mechanical impurities, and then packaged in a sealed container for storage in a dark place.

### Embodiment 2

A metal ink based on photo-thermal synergistic curing, prepared as follows: (Each raw material is measured by mass percentage)

Add 89.4% copper powder (spherical, particle size 45 μm), 4.5% RY1101, 4% di-pentaerythritol pentaacrylate, 1% NaYF4 and 0.1% BYK-028 are added to the ball mill, ceramic balls are added to the ball mill, the ball mill is closed, and placed on the ball mill at a speed of 3500 r/min for uniform mixing; Then add 0.5% I-819 and 0.5% AIBN to the ball milling tank, close the ball milling tank, and mix evenly at a speed of 1500 r/min on the ball mill; Finally, the ink is filtered through a filter to remove mechanical impurities, and then packaged in a sealed container for storage in a dark place.

### Embodiment 3

A metal ink based on photo-thermal synergistic curing, prepared as follows: (Each raw material is measured by mass percentage)

88% aluminum alloy powder (spherical, particle size 200 μm), 4.4% RY1101, 4% pentaerythritol triacrylate, 2% NaYF4 and 0.1% BYK-028 are added to the ball mill, ceramic balls are added to the ball mill, the ball mill is closed, and placed on the ball mill at a speed of 3500 r/min to mix evenly. Then add 0.5% I-819 and 1% AIBN to the ball milling tank, close the ball milling tank, and mix evenly at a speed of 1500 r/min on the ball mill. Finally, the ink is filtered through a filter to remove mechanical impurities, and then packaged in a sealed container for storage in a dark place.

### Embodiment 4

A metal ink based on photo-thermal synergistic curing, prepared as follows: (Each raw material is measured by mass percentage)

88% stainless steel alloy powder (spherical, particle size 5 μm), 4.4% Changxing 622-100, 4% Pentaerythritol triacrylate), 2% NaYF4 and 0.1% BYK-052 are added to the ball mill, ceramic balls are added to the ball mill, the ball mill is closed, and placed on the ball mill at a speed of 3000 r/min to mix evenly. Then add 0.5% I-784 and 1% AIBN to the ball milling tank, close the ball milling tank, and mix evenly at a speed of 1000 r/min on the ball mill. Finally, the ink is filtered through a filter to remove mechanical impurities, and then packaged in a sealed container for storage in a dark place.

### Embodiment 5

A metal ink based on photo-thermal synergistic curing, prepared as follows: (Each raw material is measured by mass percentage)

Mix 90% copper alloy powder (spherical, particle size 100 μm) Add 4% Changxing 6261, 4% trimethylolpropane triacrylate, 1% NaYbF4 to the ball milling tank, add ceramic balls to the ball milling tank, seal the ball milling tank, and mix evenly on the ball milling machine at a speed of 5000 r/min. Then add 0.5% I-TPO and 0.5% BPO to the ball milling tank, close the ball milling tank, and mix evenly at a speed of 2000 r/min on the ball mill. Pass the ink through the filter to remove mechanical impurities.

Add the metal ink to the ink tank of the direct writing 3D printer, extrude the metal ink from the nozzle under computer control to the printing platform for stacking, and solidify under real-time irradiation of a 980 nm laser light source to obtain the embryo; Slowly raise the temperature of the obtained green body to 450° C. in a nitrogen atmosphere at a rate of 1° C./min for debinding treatment; The defatted embryo was sintered at high temperature and high pressure (1050° C., 0.5 MPa) in a nitrogen atmosphere and slowly cooled to room temperature.

### Embodiment 6

A metal ink based on photo-thermal synergistic curing, prepared as follows: (Each raw material is measured by mass percentage)

Add 60% copper alloy powder (in sheet form, with a particle size of 100 μm), 24% RY2252, 14% pentaerythritol triacrylate, 1% NaYbF4 are added to the ball mill, ceramic balls are added to the ball mill, the ball mill is closed, and placed on the ball mill at a speed of 2000 r/min for uniform mixing. Then add 0.5% photoinitiator I-TPO and 0.5% BPO to the ball milling tank, seal the ball milling tank, and mix evenly on the ball mill at a speed of 1000 r/min. Pass the ink through the filter to remove mechanical impurities.

Add the metal ink to the ink tank of the direct writing 3D printer, extrude the metal ink from the nozzle under computer control to the printing platform for stacking, and solidify it under real-time irradiation of a 980 nm laser light source to obtain the embryo; Slowly raise the temperature of the obtained green body to 450° C. in a nitrogen atmosphere at a rate of 1° C./min for debinding treatment; The defatted embryo was sintered at high temperature and high pressure (1050° C., 0.5 MPa) in a nitrogen atmosphere and slowly cooled to room temperature.

### Embodiment 7

A metal ink based on photo-thermal synergistic curing, prepared as follows: (Each raw material is measured by mass percentage)

55% copper alloy powder (rod-shaped, particle size 500 μm), 14% RY2252, 14% pentaerythritol triacrylate, 5% NaYbF4 are added to the ball milling tank, ceramic balls are added to the ball milling tank, the ball milling tank is closed, and placed on the ball mill at a speed of 3000 r/min to mix evenly. Then add 7% I-TPO and 5% BPO to the ball milling tank, seal the ball milling tank, and mix evenly at a speed of 2000 r/min on the ball mill. Pass the ink through the filter to remove mechanical impurities.

Add the metal ink to the ink tank of the direct writing 3D printer, extrude the metal ink from the nozzle under computer control to the printing platform for stacking, and solidify under real-time irradiation of a 980 nm laser light source to obtain the embryo; Slowly raise the temperature of the obtained green body to 400° C. in a nitrogen atmosphere at a rate of 1° C./min for debinding treatment; The defatted embryo was sintered at high temperature and high pressure (1050° C., 650 MPa) in a nitrogen atmosphere and slowly cooled to room temperature.

### Embodiment 8

A metal ink based on photo-thermal synergistic curing, prepared as follows: (Each raw material is measured by mass percentage)

50% stainless steel alloy powder (spherical, particle size 100 μm) Add 6% RY3202, 30% 3,4′-epoxy cyclohexyl formate-3′,4′-epoxy cyclohexyl methyl ester, 5% Na3ScF6 to the ball milling tank, add ceramic balls to the ball milling tank, seal the ball milling tank, and mix evenly on the ball milling machine at a speed of 3000 r/min. Then add 4.5% I-784 and 4.5% BPO to the ball milling tank, close the ball milling tank, and mix evenly at a speed of 2000 r/min on the ball mill. Pass the ink through the filter to remove mechanical impurities.

Add the metal ink to the ink tank of the direct writing 3D printer, extrude the metal ink from the nozzle under computer control to the printing platform for stacking, and solidify it under real-time irradiation of a 980 nm laser light source to obtain the embryo; Slowly raise the temperature of the obtained green body to 500° C. in a nitrogen atmosphere at a rate of 5° C./min for debinding treatment; After debinding, the embryo is sintered at high temperature and high pressure (1500° C., 650 MPa) in a nitrogen atmosphere and slowly cooled to room temperature.

### Comparative Example 1

A metal ink, prepared as follows: (Each raw material is measured by mass percentage)

Add 89.4% copper powder (spherical, particle size 45 μm), 4.5% E44, 4% di pentaerythritol triacrylate, 1% NaYF4 and 0.1% BYK-028 are added to the ball mill, ceramic balls are added to the ball mill, the ball mill is closed, and placed on the ball mill at a speed of 3500 r/min to mix evenly; Then add 0.5% I-819 and 0.5% AIBN to the ball milling tank, close the ball milling tank, and mix evenly at a speed of 1500 r/min on the ball mill; Finally, the ink is filtered through a filter to remove mechanical impurities, and then packaged in a sealed container for storage in a dark place.

### Comparative Example 2

A metal ink, prepared as follows: (Each raw material is measured by mass percentage)

88% aluminum alloy powder (spherical, particle size 200 μm), 4.4% RY1101, 4% pentaerythritol triacrylate, 2% NaYF4 and 0.1% BYK-028 are added to the ball mill, ceramic balls are added to the ball mill, the ball mill is closed, and placed on the ball mill at a speed of 3500 r/min to mix evenly. Then add 1.5% AIBN to the ball milling tank, close the ball milling tank, and mix evenly at a speed of 1500 r/min on the ball mill. Finally, the ink is filtered through a filter to remove mechanical impurities, and then packaged in a sealed container for storage in a dark place.

### Comparative Example 3

A metal ink, prepared as follows: (Each raw material is measured by mass percentage)

88% aluminum alloy powder (spherical, particle size 200 μm), 4.4% RY1101, 4% pentaerythritol triacrylate, 2% NaYF4 and 0.1% BYK-028 are added to the ball mill, ceramic balls are added to the ball mill, the ball mill is closed, and placed on the ball mill at a speed of 3500 r/min to mix evenly. Then add 1.5% I-819 to the ball milling tank, seal the ball milling tank, and mix evenly at a speed of 1500 r/min on the ball mill. Finally, the ink is filtered through a filter to remove mechanical impurities, and then packaged in a sealed container for storage in a dark place.

### Comparative Example 4

A metal ink, prepared as follows: (Each raw material is measured by mass percentage)

88% stainless steel alloy powder (spherical, particle size 5 μm), 4.4% Changxing 622-100, 4% pentaerythritol triacrylate), 2% NaYF4 and 0.1% BYK-052 are added to the ball mill, ceramic balls are added to the ball mill, the ball mill is closed, and placed on the ball mill at a speed of 3000 r/min to mix evenly. Then add 0.5% I-784, 1% hydrogen peroxide Cumene into the ball mill, close the ball mill, and put it on the ball mill at a speed of 1000 r/min to mix evenly. Finally, remove the ink by passing it through the filter

Mechanical impurities should be packaged in sealed containers and stored away from light.

### Comparative Example 5

A metal ink, prepared as follows: (Each raw material is measured by mass percentage)

88% stainless steel alloy powder (spherical, particle size 5 μm), 4.4% Changxing 622-100, 4% pentaerythritol triacrylate), 2% NaYF4 and 0.1% BYK-052 are added to the ball mill, ceramic balls are added to the ball mill, the ball mill is closed, and placed on the ball mill at a speed of 3000 r/min to mix evenly. Then add 0.5% I-784, 1% benzoyl peroxide (BPO) and N, N-dimethylaniline (DMA) to the ball milling tank, seal the ball milling tank, and mix evenly on the ball milling machine at a speed of 1000 r/min. Finally, the ink is filtered through a filter to remove mechanical impurities, and then packaged in a sealed container for storage in a dark place.

### Comparative Example 6

A metal ink, prepared as follows: (Each raw material is measured by mass percentage)

Mix 90% copper alloy powder (spherical, particle size 100 μm) Add 4% Changxing 6261, 4% trimethylolpropane triacrylate, 1% NaYbF4 to the ball milling tank, add ceramic balls to the ball milling tank, seal the ball milling tank, and mix evenly on the ball milling machine at a speed of 5000 r/min. Then add 0.5% I-TPO and 0.5% BPO to the ball milling tank, close the ball milling tank, and mix evenly at a speed of 2000 r/min on the ball mill. Pass the ink through the filter to remove mechanical impurities.

Add the metal ink to the ink tank of the direct writing 3D printer, extrude the metal ink from the nozzle under computer control to the printing platform for stacking, and solidify it under real-time irradiation of a 980 nm laser light source to obtain the embryo; Slowly raise the temperature of the obtained green body to 450° C. in a nitrogen atmosphere at a rate of 1° C./min for debinding treatment; The defatted embryo was sintered at high temperature and high pressure (1050° C., 0.1 MPa) in a nitrogen atmosphere and slowly cooled to room temperature.

### Comparative Example 7

A metal ink, prepared as follows: (Each raw material is measured by mass percentage)

Mix 90% copper alloy powder (spherical, particle size 100 μm) Add 4% Changxing 6261, 4% trimethylolpropane triacrylate, 1% NaYbF4 to the ball milling tank, add ceramic balls to the ball milling tank, seal the ball milling tank, and mix evenly on the ball milling machine at a speed of 5000 r/min. Then add 0.5% I-TPO and 0.5% BPO to the ball milling tank, close the ball milling tank, and mix evenly at a speed of 2000 r/min on the ball mill. Pass the ink through the filter to remove mechanical impurities.

Add the metal ink to the ink tank of the direct writing 3D printer, extrude the metal ink from the nozzle under computer control to the printing platform for stacking, and solidify it under real-time irradiation of a 980 nm laser light source to obtain the embryo; Slowly raise the temperature of the obtained green body to 450° C. in a nitrogen atmosphere at a rate of 1° C./min for debinding treatment; The defatted embryo was sintered at high temperature and high pressure (950° C., 0.1 MPa) in a nitrogen atmosphere and slowly cooled to room temperature.

### Test Example

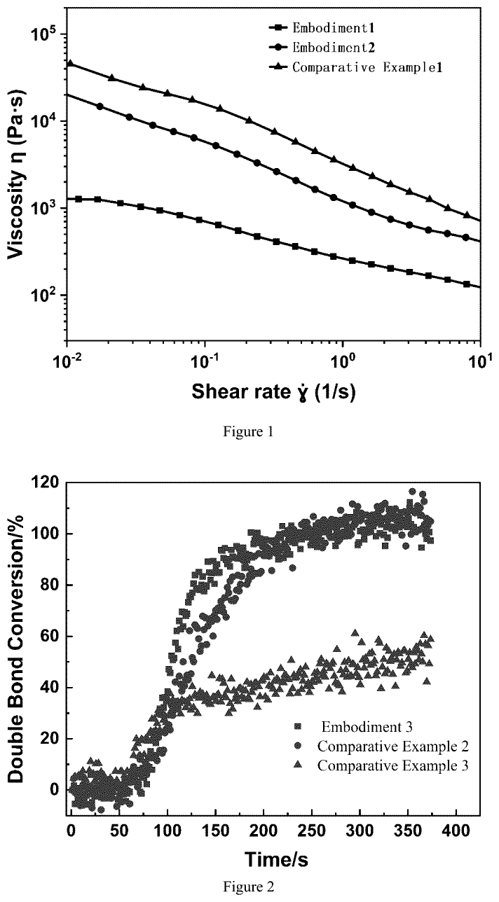

(1) Viscosity test: use a Rheometer to measure the viscosity of the ink at 25° C. Select a 25 mm conical plate with a shear rate range of 0.01 rad/s to 10 rad/s. Measure the viscosity of the sample at different shear rates, and select the viscosity at 10 rad/s shear rate as the sample viscosity. The viscosity of the metal ink obtained from embodiment 1-2 and comparative example 1 is shown in Table 1 and FIG. 1.

(2) Stability test: Place the ink in transparent glass and observe it. Record the suspended state of the powder particles in the ink every 12 hours until the powder particles settle. The stability of the metal ink obtained from Embodiment 1-2 and comparative example 1 is shown in Table 1.

TABLE 1
Viscosity and Stability of Ink

| | Ink | Ink stabilization |
|---|---|---|
| embodiments | viscosity(Pas) | time(day) |
| Embodiment 1 | 136 | >30 |
| Embodiment 2 | 460 | 14 |
| Embodiment 3 | 819 | <1 |

As shown in FIG. 1 and Table 1, the aliphatic acid modified epoxy acrylate resin selected in Embodiment 1 contains long alkyl chains and hydroxyl structures. The ink prepared has a lower viscosity, which is conducive to ink extrusion during the printing process, while effectively avoiding the sedimentation of metal particles, and obtaining high stability ink. The epoxy acrylate resin selected in Embodiment 2 contains a hydroxyl structure, which can improve the stability of the ink to a certain extent and improve the dispersibility of metal powder in the resin. For comparative example 1, it is prone to sedimentation and has a short stabilization time.

(3) Real time infrared: Apply a small amount of ink evenly on a KBr salt sheet, irradiate the sample with a 980 nm laser light source for 375 seconds, and continuously scan the exposed sample using a total reflection FT-IR spectrometer. Calculate the double bond conversion rate by calculating the peak area change of the acrylic acid double bond at 800-820 cm⁻¹. The real-time infrared curve of Embodiment 3 and the metal ink with a ratio of 2-3 is shown in FIG. 2.

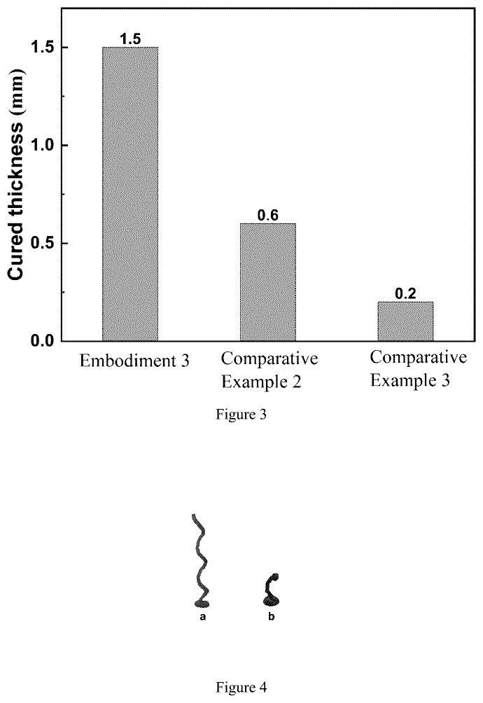

(4) Curing depth: take the light source to illuminate the cured sample, and directly measure it with Vernier scale. the curing depth of metal ink embodiment 3 and comparative example 2-3 are shown in FIG. 3. From the test data shown in FIGS. 2 and 3, it can be seen that embodiment 3 has a high curing rate and final conversion rate under the synergistic effect of light and heat, with a curing depth of up to 1.5 mm. Comparative example 2 under only thermal curing, the curing speed is slower but the final double bond conversion rate is higher, and the curing depth is about 0.6 mm; comparative example 3 under only the action of light curing, the curing speed is slower, and the final double bond conversion rate is lower. The curing depth is only 0.2 mm;

(5) Curing speed: A certain intensity light source irradiates the ink until it solidifies. The shorter the time required, the faster the curing speed.

(6) Printing effect: Observe and judge the smoothness of the printing process and the surface quality of the printed piece.

The effect of unsupported spiral structure printing for embodiment 3 and comparative example 3 is shown in FIG. 4. It can be seen from FIG. 4 that the photo-thermal synergistic effect (embodiment 3) has a good unsupported printing effect (as shown in FIG. 4-a), while the printing effect is poor only under the photocuring effect (as shown in FIG. 4-b). Unsupported printing cannot be completed with only thermal curing (comparative example 2).

(7) Chemical stability: Place the ink in a dark container and measure and record its viscosity every other day until there is a significant increase in ink viscosity.

Embodiment 4 shows the curing rate, printing effect, and chemical stability data of the proportionally obtained ink as shown in Table 2. From the data in Table 2, it can be seen that the thermal initiator AIBN used in embodiment 4 has a moderate initiation temperature, fast curing speed, good chemical stability of the ink, and can achieve an unsupported printing process with good printing effect; For the selected thermal initiator in comparative example 4, the initiation temperature of cumene hydroperoxide is more than 100° C., the curing speed is slow during printing, and the printing effect is general; The selected thermal initiator in comparative example 4 is BPO/DMA, which has a lower thermal initiation temperature and poor chemical stability of the ink. It is difficult to store the ink at room temperature, and the printing process is prone to clogging the nozzle. It can be seen that a low initiation temperature can lead to poor storage stability of ink at room temperature. Using an initiator with an excessively high initiation temperature can lead to a slower curing rate. Therefore, thermal initiators with an initiation temperature between 60° C. and 100° C. are preferred

TABLE 2

| | curing | printing | storage |
|---|---|---|---|
| | speed | effect | stability |
| Embodiment 4 | Fast | Good | Good |
| comparative | Slow | Medium | Good |
| example 4 | | | |
| comparative | Fast | Poor | Poor |
| example 5 | | | |

(8) Density: Tested according to the standard GB/T 3850-2015.

(9) Tensile strength: Tested according to standard GB/T 228-2010.

The density and tensile performance data of the printing device in embodiment 5 are shown in Table 3. From the comparison of the data in Table 3, it can be seen that the printing device in embodiment 5 can achieve higher density and tensile strength after high-temperature and high-pressure treatment, meeting the requirements for making high-strength structural components. Comparative example 6 and comparative example 7 were sintered at a lower pressure and strength, resulting in a lower density of the device and insufficient mechanical strength.

TABLE 3

| | Density | Tensile |
|---|---|---|
| | (g/cm²) | strength(MPa) |
| Embodiment 5 | 8.5 | 140 |
| comparative example 6 | 6.7 | 35 |
| comparative example 7 | 5.1 | 26 |

What is claimed is:

1. A metal ink based on photo-thermal synergistic curing, characterized in that the raw materials contained in the metal ink and the mass percentage of each raw material are:
Metal powder 50%-95%
Photosensitive resin 1%-35%
Photosensitive monomer 1%-35%
Photoinitiator 0.1% to 7%
Thermal initiator 0.1%-5%
Up-conversion material 0.1%-5%
Auxiliary agent 0%-2%;
The up-conversion material is one or more of NaYF4, BaYF5, NaGdF4, LiYF4, NaYbF4, Na3ScF6, YF3, and GdOF;
The metal powder is one or more of iron, copper, aluminum, silver, tin, magnesium, nickel, titanium, vanadium, chromium, manganese, cobalt, nickel, zinc, gallium, germanium, aluminum alloy, copper alloy, stainless steel alloy, and nickel alloy.

2. The metal ink according to claim 1, characterized in that the morphology specifications of the metal powder are one or more of spherical, needle shaped, rod shaped, or sheet shaped; the particle size of the metal powder ranges from 50 nm to 500 μm.

3. The metal ink according to claim 1, characterized in that the photosensitive resin is one or more of epoxy acrylate, polyurethane acrylate, polyester acrylate, or polyether acrylate.

4. The metal ink according to claim 1, characterized in that the photosensitive monomer is one or more of acrylic ester monomers, epoxy monomers, and vinyl ether monomers.

5. The metal ink according to claim 1, characterized in that the photoinitiator is a cracking type free radical photoinitiator, a hydrogen capture type free radical photoinitiator, or a cationic photoinitiator.

6. The metal ink according to claim 5, characterized in that the cracking type free radical photoinitiator is benzoin and its derivatives, benzoyl and its derivatives, and acetophenone derivatives α-Hydroxyl ketone derivatives α-one or more of amine ketone derivatives, acyl phosphine oxides, and sulfur-containing photoinitiators.

7. The metal ink according to claim 5, characterized in that the hydrogen withdrawing free radical photoinitiator is one or more of benzophenone and its derivatives, thioanthracene ketone and its derivatives, anthraquinone and its derivatives.

8. The metal ink according to claim 1, characterized in that the thermal initiator is one or more of organic peroxide initiators, inorganic peroxide initiators, azo type initiators, and redox initiators.

9. The metal ink according to claim 1, characterized in that the additive is one or more of defoamers, anti-settling agents, and rheological agents.

10. A method for preparing metal ink and additive manufacturing according to claim 1, characterized in that the method comprises the following steps:
(1) Add the metal ink to the ink tank of the direct ink writing 3D printer, extrude the metal ink from the nozzle under computer control to the printing specific shapes on the platform, and curing under real-time illumination of a specific light source to obtain the green body;
(2) Perform high-temperature debinding treatment on the green body obtained in step (1) in a specific atmosphere;
(3) The green body treated in step (2) is subjected to high-temperature and high-pressure sintering treatment in a specific atmosphere, and then cooled to room temperature to obtain.

11. The method according to claim 10, characterized in that in step (1), the specific light source is a laser light source with a wavelength of 10 nm to 2000 nm.

12. The method according to claim 10, characterized in that in step (2), the specific atmosphere is one or more mixed gas atmospheres of oxygen, nitrogen, argon, helium, neon, krypton, xenon, and radon; The high-temperature debinding treatment temperature is 250° C.-600° C.

13. The method according to claim 10, characterized in that in step (3), the temperature for high-temperature-high-pressure sintering treatment is 550° C.-1500° C., and the pressure is 0.5 MPa-980 MPa.
